(19) United States
(12) Patent Application Publication
(10) Pub. No.: US 2019/0373057 A1
(43) Pub. Date: Dec. 5, 2019

(54) METHOD AND DEVICE FOR SYNCHRONIZING DATA, AND ELECTRONIC DEVICE

(71) Applicant: GUANGDONG OPPO MOBILE TELECOMMUNICATIONS CORP., LTD., DONGGUAN, GUANGDONG (CN)

(72) Inventor: Hui HE, DONGGUAN, GUANGDONG (CN)

(21) Appl. No.: 16/310,925

(22) PCT Filed: Aug. 2, 2017
(86) PCT No.: PCT/CN2017/095622

§ 371 Date: Dec. 18, 2018

(30) Foreign Application Priority Data
Oct. 25, 2016 (CN) 201610942149.0

(51) Int. Cl. H04L 29/08; H04L 12/24

(52) U.S. Cl. CPC H04L 67/1095; H04L 41/06; H04L 67/2842

(57) ABSTRACT

Disclosed in the embodiments of the present invention are a data synchronization method, apparatus, storage medium and electronic device. The data synchronization method comprises: determining a data type corresponding to target data to be synchronized; determining whether the data type corresponding to the target data is a preset data type; if not, adding the target data to a data buffer area; and synchronizing the target data in the data buffer area to a cloud server after a preset period of time.

This application claims priority to Chinese Patent Application No. 201610942149.0, filed with the State Intellectual Property Office of P. R. China on Oct. 25, 2016, and titled with “Data Synchronization Method, Apparatus, Storage Medium and Electronic Device”, the entire contents of which are incorporated herein by reference.

### TECHNICAL FIELD

The present disclosure relates to a field of cloud backup technologies, and more particular to a method and a device for synthesizing data, a storage medium and an electronic device.

### BACKGROUND

Cloud backup is a kind of burgeoning cloud computation service. A cloud backup service provider provides a data storage and backup service by joining massive and heterogeneous storage devices in network together through technologies such as virtualization, distributed processing, and broadband networks. A user may access the cloud backup through mobile Internet and broadband Internet, to centrally store and securely save a large number of scattered files or folders on the terminal.

A cloud backup data synchronization is to synchronously back up the data of the terminal to a cloud server, such that the cloud server stores the same data as the terminal. For example, a short message in the terminal is synchronously backed up to the cloud server, such that the cloud server stores the same short message as the terminal.

### SUMMARY

### Technical Problem

Embodiments of the present disclosure provide a method and a device for synchronizing data, a storage medium and an electronic device, which may reduce a load of a cloud server.

### Solution For Solving Technical Problem

### Technical Solution

In a first aspect, embodiments of the present disclosure provide a method for synchronizing data, including:
determining a data type corresponding to target data to be synchronized;
determining whether the data type corresponding to the target data is a preset data type;
adding the target data to a data cache area when the data type corresponding to the target data is the preset data type; and
synchronizing the target data in the data cache area to a cloud server, after a preset interval.

In a second aspect, embodiments of the present disclosure further provide a device for synchronizing data, including:
a first determination unit, configured to determine a data type corresponding to target data to be synchronized;
a first judgment unit, configured to determine whether the data type corresponding to the target data is a preset data type;
an adding unit, configured, when it is determined by the first judgment unit that the data type is the preset data type, to add the target data to a data cache area; and
a first synchronization unit, configured to synchronize the target data in the data cache area to the cloud server after a preset interval.

In a third aspect, embodiments of the present disclosure provide a storage medium. The storage medium is configured to store a plurality of instructions. The instructions are adaptable to be loaded by a processor to execute the method for synchronizing data according to any one of embodiments of the present disclosure.

In a fourth aspect, embodiments of the present disclosure provide an electronic device, including a processor and a memory. The memory is configured to store a plurality of instructions. The instructions stored in the memory are loaded by a processor to execute the method for synchronizing data according to any one of embodiments of the present disclosure.

### Beneficial Effect of Present Disclosure

### Beneficial Effect

The method and the device for synchronizing data, the storage medium and the electronic device provided in embodiments of the present disclosure may reduce the load of the cloud server.

### BRIEF DESCRIPTION OF THE DRAWINGS

### Description to the Drawings

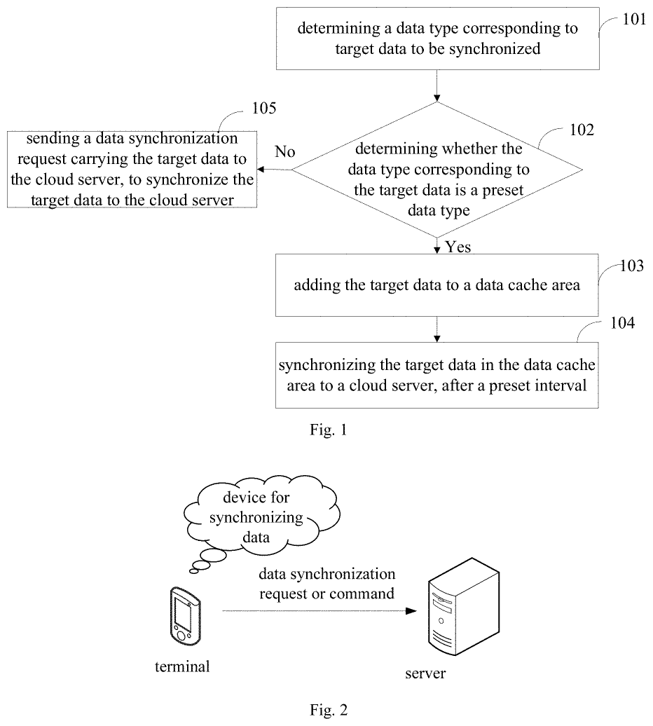

FIG. 1 is a flow chart illustrating a method for synchronizing data provided in embodiments of the present disclosure.

FIG. 2 is a schematic diagram illustrating a scenario of a system for synchronizing data provided in embodiments of the present disclosure.

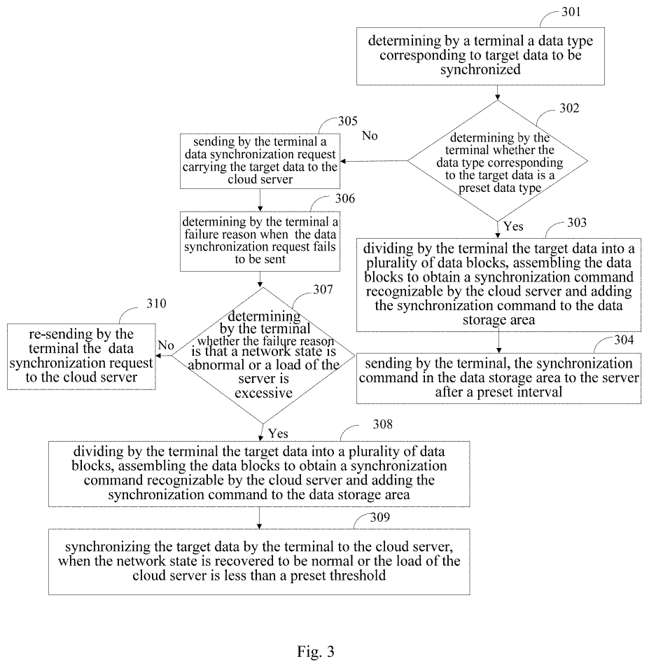

FIG. 3 is another flow chart illustrating a method for synchronizing data provided in embodiments of the present disclosure.

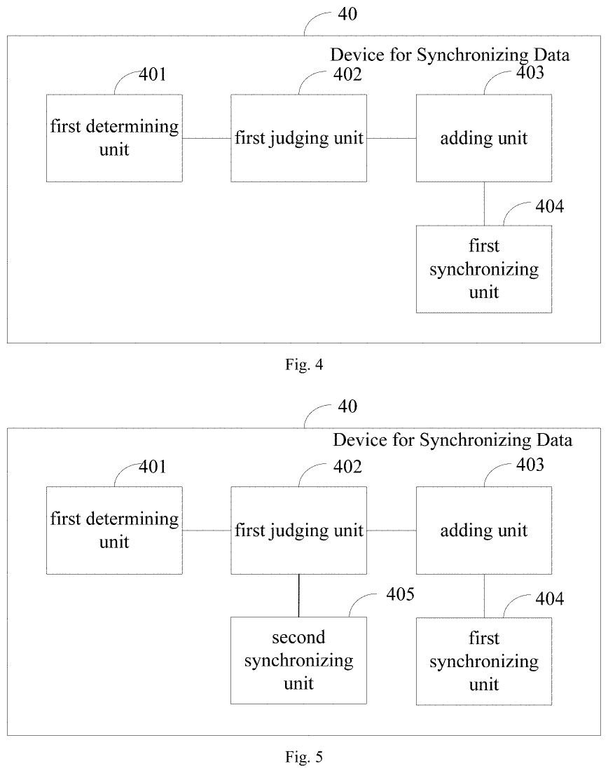

FIG. 4 is a first block diagram illustrating a device for synchronizing data provided in embodiments of the present disclosure.

FIG. 5 is a second block diagram illustrating a device for synchronizing data provided in embodiments of the present disclosure.

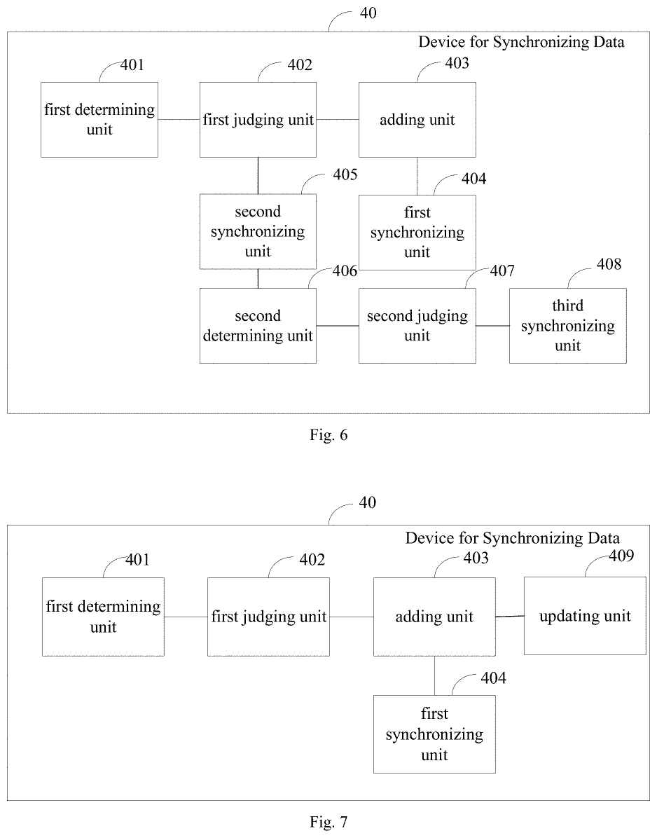

FIG. 6 is a third block diagram illustrating a device for synchronizing data provided in embodiments of the present disclosure.

FIG. 7 is a fourth block diagram illustrating a device for synchronizing data provided in embodiments of the present disclosure.

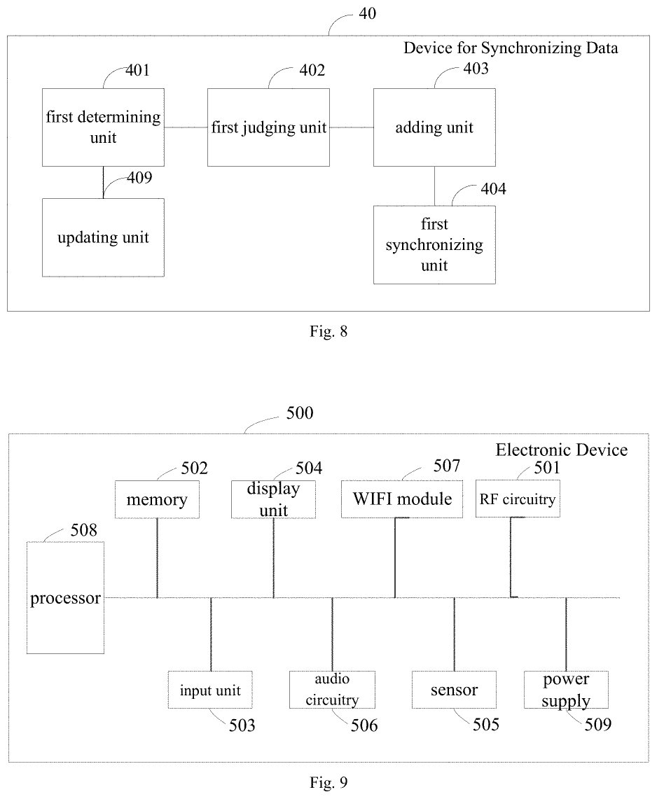

FIG. 8 is a fifth block diagram illustrating a device for synchronizing data provided in embodiments of the present disclosure.

FIG. 9 is a block diagram illustrating an electronic device provided in embodiments of the present disclosure.

### PREFERABLE EMBODIMENTS FOR IMPLEMENTING PRESENT DISCLOSURE

### Preferable Implementations of the Present Disclosure

Technical solution of the present disclosure will be described clearly and completely in combination with drawings of embodiments of the present disclosure. Obviously, described embodiments herein are only a part of embodiments of the present invention, but not all embodiments. On the basis of the embodiments of the present disclosure, all other embodiments may be obtained by those skilled in the art without any inventive work, which are all within a protective scope of the present disclosure.

In an existing cloud backup data synchronization method, when data required to be synchronized stored in the terminal changes, it is required to synchronize the changed data to the cloud server. For example, when a new short message received by the terminal, it is required to synchronize the short message to the cloud server.

However, since the data to be synchronized (such as communication record data or the like) in the terminal changes frequently, it is required to frequently synchronize the data to the cloud server, thereby causing a high load of the cloud server.

Embodiments of the present disclosure provide a method for synchronizing data, including the following.

A data type corresponding to target data to be synchronized is determined.

It is determined whether the data type corresponding to the target data is a preset data type.

When the data type is the preset data type, the target data is added to a data cache area.

After a preset interval, the target data in the data cache area is synchronized to a cloud server.

In one embodiment, the method for synchronizing data further includes the following.

When the data type corresponding to the target data is not the preset data type, a data synchronization request carrying the target data is sent to the cloud server, such that the target data is synchronized to the cloud server.

In one embodiment, the method for synchronizing data further includes the following.

When the data synchronization request fails to be sent, a failure reason why the data synchronization request fails to be sent is determined.

It is determined whether the failure reason satisfies a preset condition.

When the failure reason satisfies the preset condition, the target data is added to the data cache area.

The target data in the data cache area is synchronized to the cloud server.

In one embodiment, determining whether the failure reason satisfies the preset condition includes the following.

When the failure reason is that a network status is abnormal or a load of the cloud server is excessive, it is determined that the failure reason satisfies the preset condition.

Synchronizing the target data in the data cache area to the cloud server includes the following.

When the network state is recovered or the load of the cloud server is less than a preset threshold, the target data in the data cache area is synchronized to the cloud server.

In one embodiment, adding the target data to the data cache area includes the following.

The target data is divided into a plurality of data blocks.

The plurality of data blocks are assembled, to obtain a synchronization command recognizable by the cloud server.

The synchronization command is added to a data cache area.

Synchronizing the target data in the data cache area to the cloud server includes sending the synchronization command in the data cache area to the cloud server.

In one embodiment, after the target data is added to the data cache area, and before the target data in the data cache area is synchronized to the cloud server, the method for synchronizing data further includes the following.

During the preset interval, when it is detected that the target data changes, the target data in the data cache area is updated according to changed target data.

In one embodiment, updating the target data in the data cache area according to the changed target data includes the following.

The changed target data is divided into a plurality of new data blocks, and the plurality of new data blocks are assembled to obtain a new synchronization command recognizable by the cloud server.

The synchronization command in the data cache area is updated according to the new synchronization command.

In one embodiment, before the data type corresponding to the target data to be synchronized is determined, the method for synchronizing data further includes the following.

The data is categorized according to a frequency of data changes or a number of data changes, to obtain the data type corresponding to the data.

In one embodiment, synchronizing the target data in the data cache area to the cloud server after the preset interval includes the following.

A timing starts when the target data is added to the data cache area.

When a time duration of the timing reaches a preset time duration, the target data in the data cache area is synchronized to the cloud server. Embodiments of the present disclosure may be described from a point of view of a device for synchronizing data. The device for synchronizing data may be integrated in a terminal or other electronic device requiring for synchronizing data. The terminal may be a phone, a tablet computer or the like.

The device for synchronizing data may be integrated in the terminal in various manners. For example, the device may be installed in the terminal as a terminal application.

In at least one embodiment, there is provided a method for synchronizing data. As illustrated in FIG. 1, a flow chart of the method for synchronizing data includes the following.

In block 101, a data type corresponding to target data to be synchronized is determined.

In at least one embodiment, the block “determining the data type corresponding to the target data to be synchronized” may include the following.

A data synchronization command for indicating the target data to be synchronized is received.

The data type corresponding to the target data is determined according to the data synchronization command.

The data synchronization command may be triggered by a certain event. For example, the data synchronization command may be automatically triggered by a change of data. In at least one embodiment, when it is detected that certain data (such as certain data specified to be backed up) changes, sending the data synchronization command is triggered. A device for synchronizing data may receive the data synchronization command. For example, when it is detected that short message data specified to be backed up changes (adding, deleting or modifying), a trigger for sending the data synchronization command is sent. The data synchronization command may be automatically triggered by the system. For example, sending the data synchronization command is automatically triggered at a preset time interval.

In addition, the data synchronization command may also be triggered by triggering a trigger interface, such as a preset triggering key or an input box of the terminal. For example, when the user clicks or slides a certain synchronization icon on a synchronization interface, creating the data synchronization command is triggered. The device for synchronizing data may receive the data synchronization command.

In embodiments, the data may be categorized based on the data type in various categorization manners. In one embodiment, the data may be categorized according to a frequency of data changes or a number of data changes, to obtain the data type corresponding to the data. That is, before the block 101, the method of embodiments may further include the following.

The data is categorized according to the frequency of data changes or the number of data changes, to obtain the data type corresponding to the data.

In practical applications, the data required to be backed up may be categorized in embodiments, that is, the data specified to be backed up is categorized. For example, the data specified to be backed up, such as short message data, contact data, calling record data, and photo data, is categorized.

In a case that the data is categorized according to the frequency of data changes or the number of data changes, the data can be categorized into data types of high-frequent change, low-frequent change, and normal-frequent change. That is, the data type may include: a high-frequent data change, a low-frequent data change, a normal-frequent data change and other data types.

For example, the data type corresponding to the short message data may be categorized as the high-frequent data change, the data type corresponding to the contact data may be categorized as the low-frequent data change, the data type corresponding to the call record data may be categorized as the high-frequent data change, and the data type corresponding to the photo data may be categorized as the normal-frequent data change.

In addition, the data may be categorized according to attributions of the data (such as size) or according to an importance of the data in embodiments. For example, the data may be categorized as extremely important data, important data, normally important data, relatively important data or the like. That is, the data type may include: extremely importance, importance, normal importance, relatively importance and the like. The importance of the data may be acquired according to a type of an application having the data. For example, the importance of the data of a financial paying application is relatively high, and the importance of the data of a social application is relatively low.

The target data to be synchronized may be the data specified to be synchronized, for example, chatting record data, calling record data, photo data or the like. When the data synchronization is triggered by the change of data, the target data may be replaced with the changed data.

In block 102, it is determined whether the data type of the target data is a preset data type. If the data type of the target data is the preset data type, a block 103 is executed. Otherwise, a block 105 is executed.

In at least one embodiment, the data type corresponding to the target data may be compared with the preset data type. If the data type is same with the preset data type, it is determined that the data type is the preset data type. Otherwise, it is determined that the data type is not the preset data type.

The preset data type may be set according to actual requirements of a user. For example, categorizing the data according to the frequency of data changes or the number of data changes may be taken as an example. Considering that it is required to frequently synchronize the data frequently changing to the cloud server, in order to reduce the number of synchronizations of this type of data to the cloud server, this type of data may be stored in the data cache area in embodiments, and the data is synchronized after a time interval. That is, the preset data type may include the high-frequent data change, the normal-frequent data change or the like. When the data type corresponding to the target data is the high-frequent data change, it is determined that the data type corresponding to the target data is the preset data type.

As another example, categorizing the data according to the importance of the data is taken as an example. In order to reduce the number of data synchronizations to the cloud server, the data within a data area of a relatively low importance may be synchronized after a interval in embodiments. That is, the preset data type may include the normal importance or the relatively importance. When the data type corresponding to the target data is the normal importance, it is determined that the data type corresponding to the target data is the preset data type.

In block 103, the target data is added to the data cache area.

The data cache area may be created by the terminal before the data is synchronized. For example, the data cache area may be created before the data synchronization command is received. In at least one embodiment, before the data synchronization command is received or the data type is determined, the method according to embodiments may further include receiving a cache area creation request, and creating a corresponding data cache area according to the cache area creation request. In at least one embodiment, the cache area creation request indicates a cache area or specifies a certain cache area.

In at least one embodiment, the block “adding the target data into the data cache area” may include the following. The target data is copied. The copied target data is added to the data cache area. The target data is copied to the data cache area. The target data in embodiments may be the copied target data or may be the target data itself.

In order to improve data transmission speed or data synchronization speed, in embodiments, not only the target data is copied to the data cache area, but also the target data is divided into a plurality of data blocks, and the plurality of data blocks are assembled into the synchronization command recognizable by the cloud server. Therefore, while the data is synchronized, it is only required to extract the synchronization command from the data cache area and to send the synchronization command to the server, without assembling the data, thereby improving the data synchronization speed. That is, the block “adding the target data to the data cache area” or the block “copying the target data to the data cache area” may include the following.

The target data is divided into a plurality of data blocks.

The plurality of data blocks are assembled, to obtain the synchronization command or the synchronization request recognizable by the cloud server.

The synchronization command or the synchronization request is added to the data cache area.

There may be various manners of dividing. For example, the target data may be divided into a plurality of data blocks having a same size. In embodiments, the data blocks are assembled to obtain the synchronization command recognizable by the cloud server. That is, the data blocks may be assembled as a command or a data packet conforming to a communication protocol between the terminal and the server. The communication protocol may be a TCP/IP protocol. The block “assembling the data blocks” may include the following.

A communication protocol document of the cloud server is acquired.

The data blocks are assembled according to the communication protocol document.

In order to improve security of synchronizing the data, the target data to be synchronized is encrypted in embodiments. For example, the target data may be encrypted, and the encrypted target data may be divided. That is, the block “dividing the target data into a plurality of data blocks” may include encrypting the target data, and dividing the encrypted target data into the plurality of data blocks.

As another example, the target data may be divided, and the data blocks are encrypted. That is, the block “assembling the data blocks” may include encrypting the data blocks, and assembling the encrypted data blocks.

As another example, the dividing and the assembling may be performed, and the synchronization command is encrypted. The block “adding the synchronization command to the data cache area” may include encrypting the synchronization command and adding the encrypted synchronization command to the data cache area.

Encrypting the data in embodiments may be performed using a secret key agreed upon with the cloud server.

In block 104, after the preset interval, the target data in the data cache area is synchronized to the clouds server.

For example, after the preset interval, the data synchronization request carrying the target data is sent by the cloud server, to synchronize the target data to the cloud server.

The preset interval may be set according to actual requirements, for example, 1 minute, 10 minutes, 5 minutes, 1 hour or the like. A start point of the preset interval may be a time point when the target data is completely added to the target cache area, or may be a time point when all synchronization commands are securely added to the data cache area. In practical applications, the start point may be any time point after determining that the data type is the preset data type.

The block “after the preset interval, synchronizing the target data in the data cache area to the cloud server” may include the following.

A timing starts, when the target data is added to the data cache area.

When a time duration of the timing reaches a preset time duration, the target data in the data cache area is synchronized to the cloud server.

Adding the target data to the data cache area includes dividing the data into a plurality of data blocks. When the data blocks are assembled to obtain the synchronization command, the block “synchronizing the target data in the data cache area to the cloud server” may include sending the synchronization command in the data cache area to the cloud server.

In block 105, the data synchronization request carrying the target data is sent to the cloud server, to synchronize the target data to the cloud server.

In embodiment, when the data type of the target data is not the preset data type, the data may be synchronized in real time to the cloud server. That is, the data synchronization request is directly sent to the cloud server for synchronizing the data. For example, when the data type of the target data is the normal-frequent data change and the preset data type is the high-frequent data change, the data may be directly synchronized to the server, without caching the target data locally.

The cloud server may be frequently accessed since it is required to synchronize the data for many times due to failure of the data synchronization, causing an increase of the load of the cloud server. In order to solve the above problem, in embodiments, the data to be synchronized may be added to the data cache area when the data synchronization is failed, and the data is synchronized again, so as to reduce the number of accesses to the cloud server, thereby reducing the load of the server. That is, the method of embodiments may further include the following.

When the data synchronization request fails to be sent, a failure reason why the data synchronization request fails to be sent is determined.

It is determined whether the failure reason satisfies a preset condition.

When the failure reason satisfies the preset condition, the target data is added to the data cache area,

The target data in the data cache area is synchronized to the cloud server.

The data synchronization request synchronizes the data when it is determined that the data type of the target data is not the preset data type, i.e., the data synchronization request in the block 105.

There are various failure reasons why the data synchronization request fails to be sent. For example, the failure reasons may include the following.

Network state is abnormal or instable. The manner for determining the failure reason is to acquire parameter information of the network state and detect whether the network state is stable according to the parameter information. The parameter information of the network state may include network delay, packet loss rate, jitter, or quality of service.

Load of the cloud server is excessive. The manner for determining the failure reason is to acquire the load of the cloud server, determining whether the load is greater than a preset threshold, and determining that the load of the cloud server is excessive when the load is greater than the preset threshold.

Usable resource of the terminal is little. The manner for determining the failure reason is to acquire resource parameters of the terminal, such as a usage ratio of a processor, an occupied ratio of the storage space or the like, and determining whether the usable resource of the terminal is little according to the resource parameters.

In the method of embodiments, when the data synchronization request fails to be sent, the failure reason why the data synchronization request fails to be sent may be determined through the above manners of determining the failure reason.

There may be various preset conditions in embodiments, which may be set according to actual requirements. For example, since the data synchronization is failed due to the instable network or the excessive load of the server, the synchronization may be tried for many times, thereby causing the excessive load of the server. Therefore, in order to reduce the load of the server, the preset condition may be set as follows. The failure reason is that the network state is abnormal or the load of the cloud server is excessive. That is, the block “determining whether the failure reason satisfies the preset condition” may include the following.

When the failure reason is that the network state is abnormal or the load of the load server is excessive, it is determined that the failure reason satisfies the preset condition.

When the data synchronization request fails to be sent, the block “synchronizing the target data in the data cache area to the cloud server” may include the following. When the network sate is recovered to be normal or the load of the cloud server is less than the preset threshold, the target data in the data cache area is synchronized to the cloud server.

It may be determined whether the current data synchronization failure may cause that data synchronization of a synchronization re-sending mechanism may be failed according to the failure reason and a preset condition. Further, the data to be synchronized may be cached to the data cache area for this type of synchronization failures, and the data synchronization may be performed again. Not only the number of synchronizations to the cloud server may be reduced and the load of the cloud server may be decreased, but also other data that fails to be synchronized may be synchronized to the server timely, thereby improving the timeliness of the data synchronization.

In one embodiment, in order to ensure accuracy and consistence of synchronizing the data, when the data type is the preset data type, the target data is added to the data cache area and the data is synchronized after the preset interval, if the target data changes within the preset interval, the target data in the data cache area is updated. That is, when it is determined that the data type is the preset data type, between the block “adding the target data to the data cache area” and the block “synchronizing the target data in the data cache area to the cloud server”, the method may further include the following.

When it is detected that the target data changes during the preset interval, the target data in the data cache area is updated with changed target data.

When adding the data to the data cache area includes adding the synchronization command to the data cache area, the block “updating the target data in the data cache area according to changed target data” may include the following.

The changed target area is divided to a plurality of new data blocks, and the plurality of new data blocks are assembled, to obtain a new synchronization command recognizable by the cloud server.

The synchronization command in the data cache area is updated according to the new synchronization command. For example, the synchronization command in the data cache area may be deleted. The new synchronization command is added to the data cache area, to achieve the update of the synchronization command.

As can be seen from above, in embodiments of the present disclosure, the data type corresponding to the target data to be synchronized is determined. It is determined whether the data type corresponding to the target data is the preset data type. If the data type corresponding to the target data is not the preset data type, the target area is added to the data cache area. The target data in the data cache area is synchronized to the cloud server after the preset interval. The solution may add a certain data type of data to be synchronized to the data cache area, and may synchronize the certain data type of data to the cloud server after the preset interval. The number of the data synchronizations to the cloud server is reduced for the certain data type of the data and the access to the synchronization module may be reduced. Therefore, the load of the cloud server may be reduced and an interaction risk caused by frequent access to the synchronization module may be reduced.

In addition, in embodiments of the present disclosure, the data to be synchronized may be added to the data cache area when the data fails to be synchronized since the network state is instable or the load of the server is excessive, and the data in the data cache area may be synchronized to the server again when the network state is recovered or the load of the server is decreased, thereby avoiding frequent data synchronization to the server when the data fails to be synchronized, thereby further reducing the load of the cloud server.

In at least one embodiment, the embodiment will be described on the basis of the method of the above embodiments.

The embodiment will be described in detail taking a device for synchronizing data according to embodiments of the present disclosure being integrated to a terminal as an example.

In at least one embodiment, referring to FIG. 2, there is provided a system for synchronizing data. The system includes a server and a device for synchronizing data. The device for synchronizing data may be integrated into a terminal. The terminal may be a phone, a tablet computer, a laptop computer or the like. The server and the terminal may be connected via a wired or wireless network.

In at least one embodiment, on the basis of the system for synchronizing data, the method for synchronizing data according to the present disclosure will be described in detail. As illustrated in FIG. 3, a detailed flow chart of the method for synchronizing data may include the following.

In block 301, a data type corresponding to target data to be synchronized is determined by the terminal.

For example, a data synchronization command is received by the terminal, and the data type corresponding to the target data is determined according to the data synchronization command. The data synchronization command indicates the target data required to be synchronized. The data synchronization command may be triggered by a change of data, or may be triggered via an operation from a user.

The target data may be short message data, calling record data, contact data, or the like.

The data type may be obtained by categorizing the data in various categorization manners. In one embodiment, the data may be categorized according to a frequency of data changes or a number of data changes, to obtain the data type corresponding to the data.

For example, the data type may include: high-frequent data change, low-frequent data change, normal-frequent data change or the like.

In block 302, it is determined, by the terminal, whether the data type corresponding to the target data is the preset data type. When the data type corresponding to the target data is the preset data type, a block 303 is executed. When the data type corresponding to the target data is not the preset data type, a block 305 is executed.

The preset data type may be set according to an actual requirement of the user. For example, taking that the data is categorized according to the frequency of data changes or the number of data changes as an example, in order to reduce the number of synchronizations of this type of data to the cloud server, the preset data type may include the high-frequent data change, the normal-frequent data change or the like. When the data type corresponding to the target data is the high-frequent data change, it is determined that the data type corresponding to the target data is the preset data type.

In block 303. The target data is divided by the terminal into a plurality of data blocks. The data blocks are assembled to obtain the synchronization command recognizable by the cloud server. The synchronization command is added to the data cache area.

For example, the terminal may copy the target data and the divide the copied target date into the plurality of data blocks. Hereafter, the target data in embodiments may be the copied target data or may be the target data itself.

There are various manners of dividing. For example, the target data may be divided into the data blocks having a same size or different sizes.

In order to improve a speed of synchronizing data, in embodiments of the present disclosure, the data blocks may be assembled based on a protocol in advance, to obtain the synchronization command recognizable by the server. For example, a communication protocol document with the cloud server may be acquired, and the data blocks may be assembled according to the communication protocol document.

In block 304, after the preset interval, the synchronization command in the data cache area is sent by the terminal to the server.

For example, after the preset interval, the synchronization command is sent to the cloud server to synchronize the target data to the cloud server.

The preset interval may be set according to actual requirements, for example, 2 minutes, 8 minutes, half an hour, two hours or the like. A start point of the preset interval may be any time point after determining that the data type is the preset data type.

In one embodiment, in order to improve accuracy of synchronizing data, when it is detected that the target data changes during the preset interval, the synchronization command is updated according to changed target data. For example, the changed target data is copied. The synchronization command in the data cache area is updated according to the copied target data.

In at least one embodiment, the changed target data (or copied data of the changed target data) is divided into a plurality of new data blocks. The new data blocks are assembled to obtain a new synchronization command recognizable by the cloud server. The synchronization command in the data cache area is updated according to the new synchronization command. For example, the synchronization command in the data cache area may be replaced with the new synchronization command.

In block 305, a data synchronization request carrying the target data is sent by the terminal to the server.

In embodiments, the data may be synchronized to the cloud server in real time when determining that the data type is not the preset data type, in order to ensure the timeliness of synchronizing the data.

The server may store the target data according to the data synchronization request.

In block 306, when the data request fails to be sent, the failure reason why the data synchronization request fails to be sent is determined by the terminal.

There are various failure reasons why the data synchronization request fails to be sent. For example, the failure reasons may include that the network state is abnormal or instable, the load of the cloud server is excessive, the usable resource of the terminal is little, the server is time-out, or the like.

In block 307, it is determined by the terminal whether the failure reason is that the network state is abnormal or instable or the load of the server is excessive. If the failure reason is that the network state is abnormal or instable or the load of the server is excessive, a block 308 is executed. If the network state is not abnormal or instable or the load of the server is excessive, a block 310 is executed.

In block 308, the target data is divided by the terminal into a plurality of data blocks. The plurality of data blocks are assembled, to obtain the synchronization command recognizable by the cloud server. The synchronization command is added to the data cache area.

In order to avoid frequently accessing the cloud server caused by multi-synchronization because the data synchronization is failed, in embodiments, the data to be synchronized is added to the data cache area when the data synchronization is failed, and the data is synchronized again, to reduce the number of accesses to the cloud server and to reduce the load of the server.

In block 309, the target data in the data cache area is synchronized by the terminal to the cloud server when the network state is recovered to be normal or the load of the cloud server is less than the preset threshold.

In block 310, the data synchronization request is re-sent by the terminal to the server.

As can be seen from the above, in embodiments of the present disclosure, the data type corresponding to the target data to be synchronized is determined. It is determined whether the data type corresponding to the target data is the preset data type. If the data type corresponding to the target data is not the preset data type, the target data is added to the data cache area. The target data in the data cache area is synchronized to the cloud server after the preset interval. The solution may add the certain data type of data to be synchronized to the data cache area. The certain data type of data is synchronized to the cloud server after the preset interval, thereby reducing the number of data synchronization to the cloud server for the certain data type of data, and reducing the access to the synchronization module. Therefore, the load of the cloud server may be reduced and the interaction risk caused by frequent access to the synchronization module may be reduced.

In addition, in embodiments of the present disclosure, the data to be synchronized may be further added to the data cache area when the data synchronization is failed because the network state is abnormal or the load of the server is excessive. The data in the data cache area is synchronized again to the server when the network state is recovered or the load of the server is reduced, thereby avoiding frequent data synchronizations to the server when the data synchronization is failed, and further reducing the load of the cloud server.

Embodiments of the present disclosure provide a device for synchronizing data, including the following.

A first determining unit is configured to determine a data type corresponding to target data to be synchronized.

A first judging unit is configured to determine whether the data type corresponding to the target data is a preset data type.

An adding unit is configured to add the target data to a data cache area when it is determined by the first judging unit that the data type is the preset date type.

A first synchronizing unit is configured to synchronize the target data in the data cache area to a cloud server after a preset interval.

In one embodiment, the device for synchronizing data further includes a second synchronizing unit.

The second synchronizing unit is configured to send a data synchronization request carrying the target data to the cloud server to synchronize the target data to the cloud server, when it is determined by the first judging unit, that the target type is not the preset data type.

In one embodiment, the device for synchronizing data further includes a second determining unit, a second judging unit and a third synchronizing unit.

The second determining unit is configured to determine a failure reason why the data synchronization request fails to be sent when the data synchronization request fails to be sent.

The second judging unit is configured to determine whether the failure reason satisfies a preset condition.

The third synchronizing unit is configured to add the target data to the data cache area and to synchronize the target data in the data cache area to the cloud server, when it is determined by the second judging unit that the failure reason satisfies the preset condition.

In one embodiment, the second judging unit is configured to determine that the failure reason satisfies the preset condition when the failure reason is that the network state is abnormal or the load of the cloud server is excessive.

The third synchronizing unit is configured to synchronize the target data in the data cache area to the cloud server when the network state is recovered or the load of the cloud server is less than a preset threshold.

In one embodiment, the adding unit is configured to execute the following.

The target data is divided into a plurality of data blocks.

The plurality of data blocks are assembled to obtain a synchronization command recognizable by the cloud server.

The synchronization command is added to the data cache area.

The first synchronizing unit is configured to send the synchronization command in the data cache area to the cloud server.

In one embodiment, the device for synchronizing data further includes an updating unit.

The updating unit is configured to update the target data in the data cache area according to changed target data when it is detected that the target data changes during the preset interval after the target data is added to the data cache area by the adding unit and before the target data in the data cache area is synchronized to the cloud server by the first synchronizing unit.

In one embodiment, the updating unit is configured to divide the changed target data into a plurality of new data blocks and to assemble the plurality of new data blocks to obtain a new synchronization command recognizable by the cloud server, and to update the synchronization command in the data cache area according to the new synchronization command.

In one embodiment, the device for synchronizing data further includes a categorizing unit.

The categorizing unit is configured to categorize the data according to a frequency of data changes or a number of data changes to obtain the data type corresponding to the data, before the data type corresponding to the target data to be synchronized is determined by the first determining unit.

In one embodiment, the first synchronizing unit is configured to start a timing when the target data is added to the data cache area, and to synchronize the target data in the data cache area to the cloud server when a time duration of the timing reaches a preset time duration.

In order to implement the above method better, in at least one embodiment, there is further provided a device 40 for synchronizing data. As illustrated in FIG. 4, the device 40 for synchronizing data includes a first determining unit 401, a first judging unit 402, an adding unit 403 and a first synchronizing unit 404.

The first determining unit 401 is configured to determine a data type corresponding to target data to be synchronized.

The first judging unit 402 is configured to determine whether the data type corresponding to the target data is a preset data type.

The adding unit 403 is configured to add the target data to a target cache area when it is determined by the first judging unit 402 that the data type is the preset date type.

The first synchronizing unit 404 is configured to synchronize the target data in the data cache area to a cloud server after a preset interval.

In one embodiment, referring to FIG. 5, in order to ensure real-time data synchronization, the device for synchronizing data according to embodiments further include a second synchronizing unit 405.

The second synchronizing unit 405 is configured to send a data synchronization request carrying the target data to the cloud server to synchronize the target data to the cloud server, when it is determined by the first judging unit, that the target type is not the preset data type.

In one embodiment, referring to FIG. 6, in order to reduce the times of frequently trying to synchronize to the server caused by failure synchronizations and to reduce the load of the server, the device for synchronizing data according to embodiments may further include a second determining unit 406, a second judging unit 407 and a third synchronizing unit 408.

The second determining unit 406 is configured to determine a failure reason why the data synchronization request fails to be sent when the data synchronization request fails to be sent.

The second judging unit 407 is configured to determine whether the failure reason satisfies a preset condition.

The third synchronizing unit 408 is configured to add the target data to the data cache area, and to synchronize the target data in the data cache area to the cloud server, when it is determined by the second judging unit 407 that the failure reason does not satisfy the preset condition.

In at least one embodiment, the second judging unit 407 is configured to determine that the failure reason satisfies the preset condition, when the failure reason is that a network state is abnormal or a load of the cloud server is excessive.

Furthermore, the third synchronizing unit 408 is configured to synchronize the target data in the data cache area to the cloud server when the network state is recovered or the load of the cloud server is less than a preset threshold.

In one embodiment, in order to improve a speed of synchronizing data, the adding unit 403 in embodiments may be configured to execute the following.

The target data is divided into a plurality of data blocks.

The plurality of data blocks are assembled to obtain a synchronization command recognizable by the cloud server.

The synchronization command is added to a data cache area.

The first synchronizing unit is configured to send the synchronization command in the data cache area to the cloud server.

In one embodiment, in order to improve accuracy of synchronizing data, referring to FIG. 7, the device for synchronizing data according to embodiments may further include an updating unit 409.

The updating unit 409 is configured, after the target data is added to the data cache area by the adding unit 403 and before the target data in the data cache area to the cloud server by the first synchronizing unit 404, update the target data in the data cache area according to changed target data when it is detected that the target data changes during the preset interval.

In one embodiment, the updating unit 409 may be configured to divide the changed target data into a plurality of new data blocks, assemble the plurality of new data blocks to obtain a new synchronization command recognizable by the cloud server; and update the synchronization command in the data cache area according to the new synchronization command.

In one embodiment, referring to FIG. 8, the device for synchronizing data may further include a categorizing unit 410. The categorizing unit 410 is configured to categorize data according to a frequency of data changes or a number of data changes, to obtain the data type corresponding to the data, before the data type corresponding to the target data to be synchronized is determined by the first determining unit 401.

In one embodiment, the first synchronizing unit 404 may be configured to start a timing when the target data is added to the data cache area; and to synchronize the target data in the data cache area to the cloud server when a time duration of the timing reaches a preset time duration.

In implementations, the above units may be realized separately as individual entities, or may be realized as a single or several entities through combination. Implementations of the above units may be referred to method embodiments described above, which are not elaborated herein.

The device for synchronizing data may be integrated into a terminal, such as integrated into a phone, a tablet computer, a laptop computer or the like.

As can be seen, in embodiments of the present disclosure, the data type corresponding to the target data to be synchronized is determined via the first determination unit 40. It is determined via the first judging unit 402, whether the data type corresponding to the target data is the preset data type. The target data is added by the adding unit 403 to the data cache area when the data type is the preset data type. The target data in the data cache area is synchronized via the first synchronizing unit 404 to the cloud server after the preset interval. This solution may add a certain data type of data to be synchronized to the data cache area, and may synchronize the certain data type of data to the cloud server after the preset interval, thereby reducing the number of data synchronizations to the cloud server for the certain data type of data, and reducing accesses to a synchronization module. Therefore, the load of the cloud server may be reduced and an interaction risk caused by frequent access to the synchronization module may be reduced.

In addition, in embodiments of the present disclosure, the data to be synchronized may be added to the data cache area when the data fails to be synchronized since the network state is instable or the load of the server is excessive. The data in the data cache area may be synchronized again to the server when the network state is recovered or the load of the server is decreased. Therefore, frequent data synchronizations to the server may be avoided when the data synchronization is failed, and further reducing the load of the cloud server.

Embodiments of the present disclosure further provide an electronic device including a processor and a memory. The memory is configured to store a plurality of instructions. The processor is configured to load the instructions stored in the memory to execute the method for synchronizing data according to any one of embodiments of the present disclosure.

In at least one embodiment, embodiments of the present disclosure further provide an electronic device. The electronic device may be a terminal, such as a tablet computer, a phone or other mobile terminals, as illustrated in FIG. 9. FIG. 9 is a schematic diagram illustrating a mobile terminal provided in embodiments of the present disclosure. The mobile terminal 500 may include a radio frequency (RF) circuitry 501, a memory 502 having one or more computer readable storage medium, an input unit 503, a display unit 504, sensors 505, an audio circuitry 506, a wireless fidelity (WIFI) module 507, a processor 508 having one or more processing kernels, and a power supply 509. It may be understood by those skilled in the art that, the structure illustrated in FIG. 9 does not limit the structure of the mobile terminal, which may include less or more components than those illustrated in FIG. 9 or include combinations thereof, or have a different arrangement of components.

The RF circuitry 501 may be configured to receive or transmit a signal during a process of transmitting or receiving a message or making a call. In at least one embodiment, after downlink data of a base station is received, the downlink data is transmitted to one or more processors 508 for processing. Additionally, uplink data related is transmitted to the base station. In general, the RF circuitry 501 includes, but not limited to, an antenna, at least one amplifier, a tuner, one or more oscillators, a subscriber identity module (SIM) card, a transceiver, a coupler, a low noise amplifier (LNA), a diplexer and the like. Furthermore, the RF circuitry 501 may be further configured to communicate with other devices via wireless communication and network. The wireless communication may adopt any communication standard or protocol, which includes, but not limited to, global system of mobile communication (GSM), general packet radio service (GPRS), code division multiple access (CDMA), wideband code division multiple access (WCDMA), long term evolution (LTE), e-mail, short messaging service (SMS) and the like.

The memory 502 may be configured to store application programs or modules. The application programs stored in the memory 502 includes executable codes. The application programs may be combined into various functional modules. The processor 508 is configured to execute various functional applications and data processes by running the applications programs stored in the memory 502. The memory 502 may include a program storage region and a data storage region. The program storage region may store an operation system, at least one function-required application programs (such as sound playing function, image displaying function) and the like. The data storage region may store data produced by using the mobile terminal (such as audio data, a contact book) and the like. In addition, the memory 502 may include a high speed random access memory and may include a non-volatility memory, such as at least one disk memory, a flash memory, or other volatility solid state memory. Accordingly, the memory 502 may further include a memory controller to provide accesses by the processor 503 and the input unit 503 to the memory 502.

The input unit 503 may be configured to receive figures, character information or user characteristic information (such as fingerprint) inputted and generate a keyboard signal input, a mouse single input, an operating level signal input, an optical signal input or a trackball signal input related to a user setup or functional control. In one embodiment, the input unit 503 may include touch-sensitive surface and other input devices. The touch-sensitive surface may be called as a touch display screen or a touch panel, and may be configured to collect touch operations near or on the touch-sensitive surface (such as an operation of a user on the touch-sensitive surface or near the touch-sensitive surface with a finger, a stylus or other suitable objects or attachments), and drive corresponding connected device according to a preset program. In at least one embodiment, the touch-sensitive surface may include a touch detection device and a touch controller. The touch detection device is configured to detect an orientation of the user's touch, detect a signal caused by the touch operation and send the signal to the touch controller. The touch controller is configured to receive the touch information on the touch detection device, convert the touch information to touch point coordinates, and send the touch point coordinates to the processor 508. Furthermore, the touch controller may receive and execute a command sent from the processor 508. In addition, the touch-sensitive surface may be implemented as resistance typed, capacitive typed, infrared typed and surface acoustic wave typed. In addition to the touch-sensitive surface, the input unit 503 may further include other input devices. In detail, the other input devices may include, but not limited to, one or more of a physical keyboard, a functional key (such as a volume control key and the like), a fingerprint recognition module, a trackball, a mouse, an operating level and the like.

The display unit 504 may be configured to display information inputted by the user or information provided to the user or various graphical user interfaces of the mobile terminal. The graphical user interfaces may be consisted of graphs, text, icons, videos and others. The display unit 504 may include a display panel. In at least one embodiment, the display panel may be configured as a liquid crystal display (LCD), an organic light-emitting diode (OLED) and the like. Further, the touch-sensitive surface may cover the display panel. When the touch-sensitive surface detects the touch operation on or near the touch-sensitive surface, the touch operation is transmitted to the processor 508 to determine a type of the touch event. Thereafter, the processor 508 provides a corresponding visual output on the display panel according to the type of the touch event. Although the touch-sensitive surface and the display panel are used as two separate components to realize an input and output functions illustrated in FIG. 9, in certain embodiments, the touch-sensitive surface and the display panel may be integrated to realize the input and output functions.

The mobile terminal may further include at least one sensor 505, such as an optical sensor, a motion sensor and other sensors. In detail, the optical sensor may include a surrounding light sensor and a proximity sensor. The surrounding light sensor may adjust a brightness of the display panel according to brightness of the surrounding lights. The proximity sensor may light the display panel and/or backlight unit off when the mobile terminal moves near ears of the user. As a kind of motion sensor, a gravity acceleration sensor may detect acceleration values in various directions (generally three axes), measure a value and a direction of gravity when being static, and identify a status of the phone (such as horizontal screen and vertical screen switching, related games, magnetometer status calibration), shake-related functions (such as a pedometer, a knocking) and the like. Furthermore, the mobile terminal may be configured with a gyroscope, a barometer, a thermometer, an infrared sensor and other sensors, which are not elaborated herein.

The audio circuitry 506 may be configured to provide an audio interface between the user and the mobile terminal via a loudspeaker and a microphone. The audio circuitry 506 may transmit an electrical signal transformed from received audio data to the loudspeaker. The loudspeaker converts the electrical signal to a sound signal and output the sound signal. In another aspect, the microphone may be configured to transform a collected sound single to an electrical signal. The audio circuitry 506 receives and transforms the electrical signal to audio data and outputs the audio data to the processor 508 for processed. The audio data processed by the processor 508 may be transmitted to another mobile terminal via the RF circuitry 501 or may be stored in the memory 502 to be subsequently processed. The audio circuitry 506 may further include an earplug, to provide an external earphone for communication with the mobile terminal.

The WiFi is a short distance wireless communication technology. The mobile terminal may help the user to receive or send an e-mail, search webpages, access to stream medium via the WiFi module 507. The WiFi module 507 provides a wireless broadband Internet access. Although the WiFi module 507 is illustrated in FIG. 9, it may be understood that, the WiFi module 507 is not necessary for the mobile terminal, thus it may be omitted according to requirements without changing an essential scope of the present disclosure.

The processor 508 is a control center of the mobile terminal, which utilizes various interfaces and wires to connect various parts of the mobile terminal. By running or executing the application programs stored in the memory 502, and by calling data stored in the memory 502, various functions and data processing functions of the mobile terminal may be executed, thus monitoring the mobile terminal entirely. In at least one embodiment, the processor 508 may include one or more processing kernels. In one embodiment, the processor 508 may be integrated with an application processor or a modem processor. The application processor is configured to process the operation system, a user interface and an application program. The modem processor is configured to process wireless communication. It may be understood that, the above modem controller may be not integrated in the processor 508.

The mobile terminal may further include the power supply 509 (such as a battery), configured to provide power to various components. In an embodiment, the power supply may be logically connected to the processor 508 via a power management system, thereby managing functions, such as charging, discharging and power consumption via the power management system. The power supply 509 may further include one or more direct current power supplies or alternative current poser supplies, one or more re-chargeable systems, one or more power supply failure detection circuitries, one or more power supply transducers or inverters, one or more power supply status indicators or the like.

Although not illustrated in FIG. 9, the mobile terminal may further include a camera, a Bluetooth module or the like, which is not elaborated herein.

In embodiments, the processor 508 of the mobile terminal may load the executable codes corresponding to progresses of one or more application programs to the memory 502, and run the application programs stored in the memory 502, to execute various functions as follows.

A data type corresponding to target data to be synchronized is determined. It is determined whether the data type corresponding to the target data is a preset data type. If the data type corresponding to the target data is not the preset data type, the target data is added to a data cache area. The target data in the data cache area is synchronized to the cloud server after a preset interval.

The processor 508 may be further configured to execute following functions. When the data type corresponding to the target data is not the preset data type, a data synchronization request carrying the target data is sent to the cloud server, to synchronize the target data to the cloud server.

In some implementations, the processor 508 is further configured to execute following functions. When sending the data synchronization request is failed, a failure reason why sending the data synchronization request is failed is determined.

It is determined whether the failure reason satisfies a preset condition.

When the failure reason satisfies the preset condition, the target data is added to the data cache area.

The target data in the data cache area is synchronized to the cloud server.

In some implementations, the processor 508 may be configured to divide the target data into a plurality of data blocks, to assemble the plurality of data blocks to obtain a synchronization command recognizable by the cloud server, to add the synchronization command to a data cache area, and to send the synchronization command in the data cache area to the cloud server.

In some embodiments, the processor 508 is further configured to execute following functions. After the target data is added to the data cache area, and before the target data in the data cache area is synchronized to the cloud server, the target data in the data cache area is updated according to updated target data when it is detected that the target data changes during the preset interval.

In above embodiments, descriptions made to above embodiments have different emphasis. For those that are not described in detail in some embodiments, detailed descriptions made to the method for synchronizing data may be referred to, which are not elaborated herein.

Those skilled in the art may understand that all or a part of blocks in various method of the above embodiments may be completed by instructing related hardware via instructions. The programs may be stored in a computer readable storage medium. The storage medium may include a read only memory (ROM), a random access memory (RAM), a magnetic disk, an optical disk or the like.

Detailed descriptions are made to the above method for synchronizing data, a device for synchronizing data, a storage medium and an electronic device provided in embodiments of the present disclosure. Specific examples are used in the present disclosure to illustrate principles and implementation manners of the present application. The above descriptions of embodiments are only used for understanding the method of the present disclosure and its key thought. For those skilled in the art, according to the thought of the present disclosure, specific implementation manners and application scopes may vary. In conclusion, the context should be not construed to limit the present application.

1. A method for synchronizing data, comprising:
determining a data type corresponding to target data to be synchronized;
determining whether the data type corresponding to the target data is a preset data type;
adding the target data to a data cache area when the data type corresponding to the target data is the preset data type; and
synchronizing the target data in the data cache area to a cloud server, after a preset interval.

2. The method according to claim 1, further comprises:
when the data type corresponding to the target data is not the preset data type, sending a data synchronization request carrying the target data to the cloud server, to synchronize the target data to the cloud server.

3. The method according to claim 2, further comprising:
determining a failure reason why the data synchronization request fails to be sent when the data synchronization request fails to be sent;
determining whether the failure reason satisfies a preset condition;
adding the target data to the data cache area when the failure reason satisfies the preset condition; and
synchronizing the target data in the data cache area to the cloud server.

4. The method according to claim 3, wherein determining whether the failure reason satisfies the preset condition comprises:
determining that the failure reason satisfies the preset condition when the failure reason is that a network state is abnormal or a load of the cloud server is greater than a preset threshold; and
wherein synchronizing the target data in the data cache area to the cloud server comprises:
synchronizing the target data in the data cache area to the cloud server when the network state is recovered or the load of the cloud server is less than the preset threshold.

5. The method according to claim 1, wherein adding the target data to the data cache area comprises:
dividing the target data into a plurality of data blocks;
assembling the plurality of data blocks to obtain a synchronization command recognizable by the cloud server;
adding the synchronization command to a data cache area; and
sending the synchronization command for synchronizing the target data in the data cache area to the cloud server.

6. The method according to claim 1, after adding the target data to the data cache area and before synchronizing the target data in the data cache area to the cloud server, further comprising:
updating the target data in the data cache area according to changes in the target data when detecting that the target data changes during the preset interval. (Currently Amended) The method according to claim 6, wherein updating the target data in the data cache area according to the changes in the target data comprises:
dividing the changed target data into a plurality of new data blocks;
assembling the plurality of new data blocks to obtain a new synchronization command recognizable by the cloud server; and
updating the synchronization command in the data cache area according to the new synchronization command.

8. The method according to claim 1, before determining the data type corresponding to the target data to be synchronized, further comprising:
categorizing the target data according to a frequency of data changes or a number of data changes, to obtain the data type corresponding to the target data.

9. The method according to claim 1, wherein synchronizing the target data in the data cache area to the cloud server after the preset interval comprises:
starting a timing when the target data is added to the data cache area; and
synchronizing the target data in the data cache area to the cloud server when a time duration of the timing reaches a preset time duration.

10-18. (canceled)

19. A non-transitory computer readable storage medium, having a plurality of instructions stored therein, wherein the instructions are adapted to be loaded by a processor to:
determine a data type corresponding to target data to be synchronized;
determine whether the data type corresponding to the target data is a preset data type;
add the target data to a data cache area when the data type corresponding to the target data is the preset data type; and
synchronize the target data in the data cache area to a cloud server after a preset interval.

20. An electronic device, comprising a processor and a memory, wherein the memory is configured to store a plurality of instructions, and the processor is configured to load the instructions stored in the memory to:
determine a data type corresponding to target data to be synchronized;
determine whether the data type corresponding to the target data is a preset data type;
add the target data to a data cache area when the data type corresponding to the target data is the preset data type; and
synchronize the target data in the data cache area to a cloud server after a preset interval.

21. The method according to claim 5, wherein assembling the plurality of data blocks comprises:
acquiring a communication protocol document with the cloud server; and
assembling the plurality of data blocks according to the communication protocol document.

22. The method according to claim 5, further comprising:
encrypting the target data and dividing the encrypted target data into the plurality of data blocks;
encrypting the plurality of data blocks, and assembling the plurality of encrypted data blocks to obtain the synchronization command; or
encrypting the synchronization command and sending the encrypted synchronization command to the cloud server.

23. The method according to claim 1, before determining the data type corresponding to the target data to be synchronized, further comprising:
receiving a cache area creation request; and creating the data cache area based on the cache area creation request.

24. The method according to claim 1, wherein adding the target data to the data cache area comprises:
copying the target data; and adding the copied target data to the data cache area.

25. The electronic device according to claim 20, wherein the processor is further configured to load the instructions stored in the memory to:
send a data synchronization request carrying the target data to the cloud server to synchronize the target data to the cloud server when the data type corresponding to the target data is not the preset data type.

26. The electronic device according to claim 25, wherein the processor is further configured to load the instructions stored in the memory to:
determine a failure reason why the data synchronization request fails to be sent when the data synchronization request fails to be sent;
determine whether the failure reason satisfies a preset condition;
add the target data to the data cache area when the failure reason satisfies the preset condition; and
synchronize the target data in the data cache area to the cloud server.

27. The electronic device according to claim 26, wherein the processor is configured to load the instructions stored in the memory to:
determine that the failure reason satisfies the preset condition when the failure reason is that a network state is abnormal or a load of the cloud server is less than a preset threshold; and
synchronize the target data in the data cache area to the cloud server when the network state is recovered or the load of the cloud server is less than the preset threshold.

28. The electronic device according to claim 20, wherein the processor is further configured to load the instructions stored in the memory to:
divide the target data into a plurality of data blocks;
assemble the plurality of data blocks to obtain a synchronization command recognizable by the cloud server;
add the synchronization command to a data cache area; and
send the synchronization command in the data cache area to the cloud server.

29. The electronic device according to claim 20, wherein after the target data is added to the data cache area and before the target data in the data cache area is synchronized to the cloud server, the processor is further configured to load the instructions stored in the memory to:
update the target data in the data cache area according to changes in the target data when it is detected that the target data changes during the preset interval.
